(19) United States
(12) Patent Application Publication
(10) Pub. No.: US 2014/0229125 A1
(43) Pub. Date: Aug. 14, 2014

(54) METHOD OF DETECTING PRELOAD OF BALL SCREW

(71) Applicant: NATIONAL CHUNG CHENG UNIVERSITY, Min-Hsiung (TW)

(72) Inventors: Chih-Chun CHENG, Tainan City (TW); Ping-Chun TSAI, Taipei City (TW); Hung-Chun HUANG, Kaohsiung City (TW); Kai-Hung LO, Taipei City (TW); Wen-Nan CHENG, Tainan City (TW); Teng-Der TSAI, Taipei City (TW); Fu-Ching WANG, Taichung City (TW); Chi-Rung LI, Changhua City (TW)

(73) Assignee: NATIONAL CHUNG CHENG UNIVERSITY, Min-Hsiung (TW)

(21) Appl. No.: 13/763,350

(22) Filed: Feb. 8, 2013

(51) Int. Cl. G01B 5/14

(52) U.S. Cl. CPC G01B 5/14
USPC 702/56

(57) ABSTRACT

A method of detecting a preload of a ball screw is to acquire an operational signal of the ball screw, to process the operational signal via a theoretical ball pass order and an order tracking analysis procedure to acquire an actual ball pass order, to compare and judge the relationship between the actual ball pass order and the theoretical ball pass order via a preload judgment procedure, and finally to observe the proportion of occurrence of side band of the actual ball pass order to determine the preload status of the ball screw.

### BACKGROUND OF THE INVENTION

1. Field of the Invention

The present invention relates generally to detection of a preload of a ball screw and more particularly, to a method of detecting a preload of a ball screw.

2. Description of the Related Art

As the industry of machine tools develops, the requirement for positioning precision of the machine tools becomes higher and higher. Inside the machine tools, a ball screw is an essential component for high positioning precision. Generally speaking, before a ball screw leaves the factory, the manufacturer usually applies preloading to the ball screw in order to eliminate the axial backlash of the ball screw in such a way that the positioning precision and stiffness of the ball screw can be enhanced. However, when the ball screw is used for a while, the axial backlash of the ball screw will occur, indicating that the preload becomes decreasing to lower and the ball screw loses its positioning precision. As far as the conventional judgment based on the general experience in practice for the service life of the ball screw, after the ball screw is used for a period of time, a user usually installs a whole new ball screw instead of the old ball screw. In this way, the old ball screw which is still serviceable as a whole is replaced to result in waste.

Besides, the preload exists inside the ball screw, so the current preload cannot be measured directly but by a torque sensor, a tension meter, accelerometer, or displacement meter for measuring the preload of the ball screw conventionally. However, in practice, the torque sensor is expensive, the tension meter cannot provide on-line measurement, and the accelerometer or the displacement meter frequently generates unstable vibrations to prevent the measurement of the preload from being highly uniform. Besides, the vibration coming from the machine tool itself will also be transmitted to the ball screw, so excessive noises will occur to make the accuracy of the preload of the ball screw questionable.

In addition, Taiwan Patent Laid-open No. 201135209 disclosed that a detecting device for a transmission member could detect the ball pass frequency of the ball screw to determine whether the ball screw is abnormal, merely determining whether the ball pass frequency of the ball screw is cyclically variable and comparing the difference between the cyclically variable ball bass frequency and the default to determine the status of the ball screw. This application proposed a brand-new transmission-monitoring member and however, the present invention is to propose a detecting method based on the conventional vibration or audio detector for detection and analysis of the ball pass frequency, so the method and technical features of the present invention are different from those of that application.

### SUMMARY OF THE INVENTION

The primary objective of the present invention is to provide a method of detecting a preloading variance of a ball screw where a detecting device, a signal-capturing device, and a computer are used for tracking the ball pass order of the ball screw in order to observe the preloading variance. The detecting device is connected with the ball screw for detecting an operational status of the ball screw. The operational status includes rotary speed of the ball screw and vibration or sound of the ball screw. The signal-capturing device is connected with the detecting device and the computer for receiving and converting the operational status into an operational signal. The computer stores a preload judgment program. When the ball screw is operated, the computer operates the preload judgment program to carry out the method of detecting the preloading variance of the ball screw. The method includes the steps of receiving the operational signal; processing the operational signal; carrying out an order tracking analysis procedure for statistical analysis of the operational signal for tracking an actual ball pass order of the ball screw; providing a theoretical ball pass order indicating that the preload loss in the ball screw; and carrying out a preload judgment procedure containing an order comparison sub-procedure and a quantification side band sub-procedure of ball pass order. The order comparison sub-procedure includes the step of comparing the actual ball pass order and the theoretical ball pass order. The quantification side band sub-procedure includes the step of judging whether the actual ball pass order is accompanied with any side band. If the order comparison sub-procedure judges that the actual ball pass order is away from the theoretical ball pass order, the preload judgment procedure will judge that the ball screw is of preload. If the order comparison procedure judges that the actual ball pass order approaches the theoretical ball pass order and the quantification side band sub-procedure judges that the actual ball pass order is not accompanied with any side band, the preload judgment procedure will determine that the ball screw is of preload. If the order comparison sub-procedure judges that the actual ball pass order approaches the theoretical ball pass order and the quantification side band sub-procedure judges that the actual ball pass frequency is accompanied with side band, the preload judgment procedure will judge that the preload loss in the ball screw.

In light of the above, the method of the present invention can effectively detect and judge the preload-status of the ball screw, standardize observation of the preload-status of the ball screw, and effectively acquire the timing of replacing the ball screw.

Specifically, the order tracking analysis procedure includes the steps of processing the operational signal via a structure equation and a data equation; distilling the noises from the operational signal; and filtering out the noises via a mathematical optimization algorithm to acquire the actual ball pass order. In this way, the method of the present invention can apply the observation of higher resolution to the to-be-tracked actual ball pass order to avoid interference of the noises.

### BRIEF DESCRIPTION OF THE DRAWINGS

FIG. 1 shows a perspective view of a ball screw and a block diagram in accordance with a preferred embodiment of the present invention.

FIG. 2 is a flow chart of the preferred embodiment of the present invention.

FIG. 3 is a resultant chart of measurement and analysis while the preload loss in the ball screw.

FIG. 4 is a resultant chart of measurement and analysis while the ball screw is of preload.

FIG. 5 is a flow chart of a step S53 in accordance with the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that these embodiments are given by way of illustration only, thus are not limitative of the claim scope of the present invention.

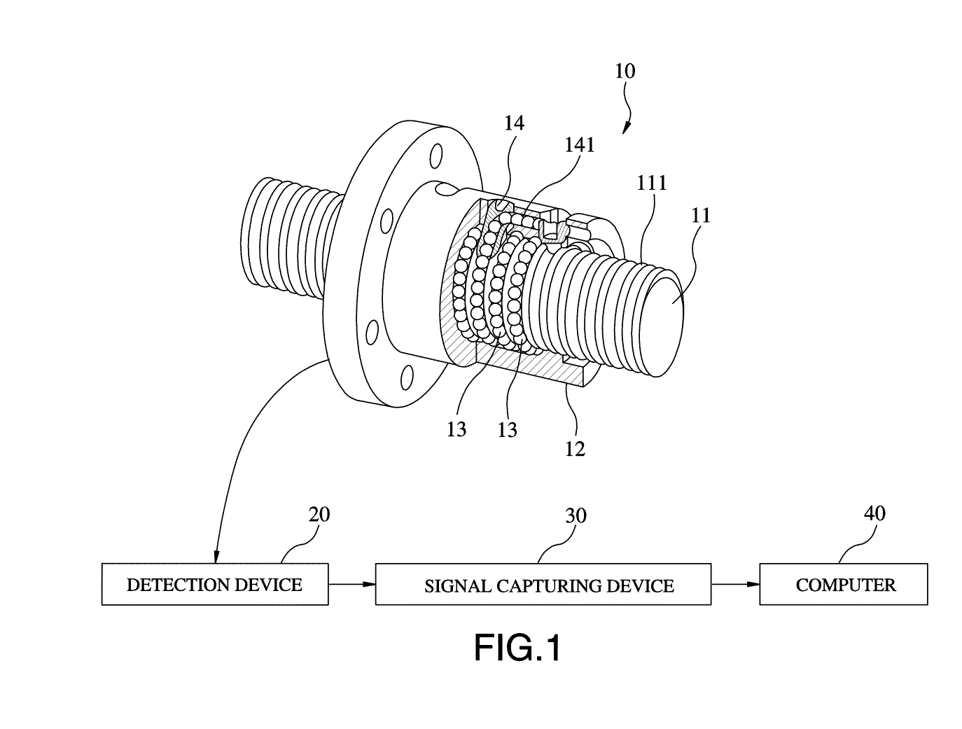

Referring to FIG. 1, a ball screw preload detection system in accordance with a preferred embodiment of the present invention is composed of a ball screw 10, a detection device 20, a signal-capturing device 30, and a computer 40. The detailed descriptions and operations of these elements as well as their interrelations are recited in the respective paragraphs as follows.

The ball screw 10 includes a screw shaft 11, a screw nut 12, a plurality of balls 13, and a return tube 14. The screw shaft 11 has a groove 111 wound around an external periphery thereof. The screw nut 12 is slidably sleeved onto the screw shaft 11 and movable along the screw shaft 11. The balls 13 are mounted between the screw shaft 11 and the screw nut 12 and located inside the groove 111. The return tube 14 is mounted onto the screw nut 12 and has a return passage 141 in communication with the groove 111 for the balls 13 to pass through. In this way, the balls 13 can keep passing through the groove 111 and the return passage 141 cyclically.

The detection device 20 is connected with the ball screw 10 for detecting an operational status of the ball screw 10. The operational status includes rotary speed of the ball screw 10 and vibration or sound of the ball screw 10. In this embodiment, the detection device 20 can detect not only the rotary speed of the ball screw 10 but the vibration of the ball screw 10, so the detection device 20 is formed of a vibration sensor and a screw tachometer. Besides, the detection device 20 can be embedded into the screw nut 12 of the ball screw 10, so it is not limited to what FIG. 1 shows.

The signal-capturing device 30 is connected with the detection device 20 for converting the operational status detected by the detection device 20 into an operational signal. The computer 40 is connected with the signal-capturing device 30 for receiving the operational signal and stores a preload judgment program. When the computer 40 executes the preload judgment program, the computer 40 can carry out the method of detecting the preload of the ball screw 10, after receiving the operational status, and then determine whether the preload of the ball screw 10 is abnormal or not and whether the ball screw 10 needs replacement.

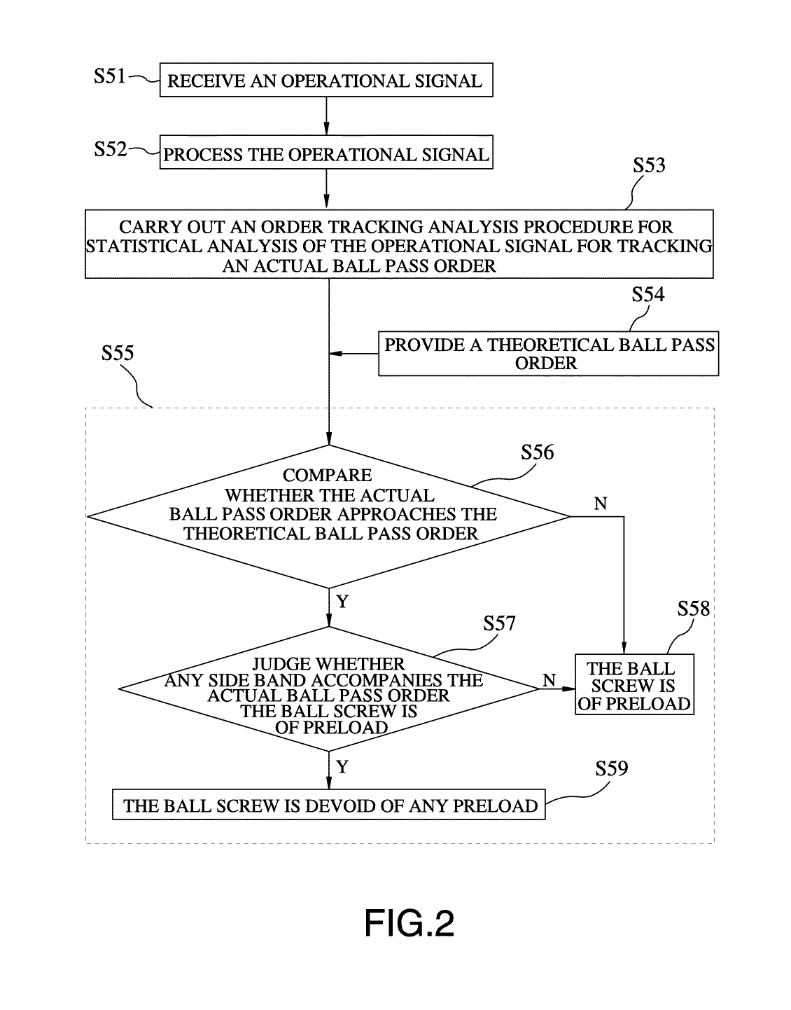

Referring to FIG. 2, a method of detecting the preload of the ball screw in accordance with the preferred embodiment of the present invention includes the following steps.

S51: Receive the operational signal.

S52: Process the operational signal.

S53: Carry out an order tracking analysis procedure for statistical analysis of the operational signal for tracking an actual ball pass order.

S54: Provide a theoretical ball pass order indicating the ball screw is devoid of any preload.

S55: Carry out a preload judgment procedure having an order comparison sub-procedure S56 and a quantification side band sub-procedure S57.

S56: Compare whether the actual ball pass order approaches the theoretical ball pass order.

S57: Judge whether any side band accompanies the actual ball pass order.

If the actual ball pass order is away from the theoretical ball pass order, proceed to a sub-step S58: Judge that the ball screw is of preload. If the actual ball pass order approaches the theoretical ball pass order and the actual ball pass order is not accompanied with any side band, proceed to the sub-step S58. If the actual ball pass order approaches the theoretical ball pass order and the actual ball pass order is accompanied with side band, proceed to the sub-step S59: Judge that the ball screw is devoid of any preload. The ball pass frequency indicates how many times the balls of the ball screw impinges the return tube while passing through the return tube. The ball pass frequency is a multiple of the ball screw rotary speed. This multiple corresponds to a specific order in an order spectrum, i.e. called ball pass order, and is a constant regardless of the varying rotary speed of ball screw. When the ball screw is of preload, the screw nut of the ball screw applies positive force to the balls to enable the balls to impinge an entrance (as known as lip) of the return tube subject to the positive force while passing through the return tube. The theoretical ball pass frequency is inferred based on the geometrical relationships of internal structure of the ball screw while each two adjacent balls abut against each other and none of any positive force is applied to the balls.

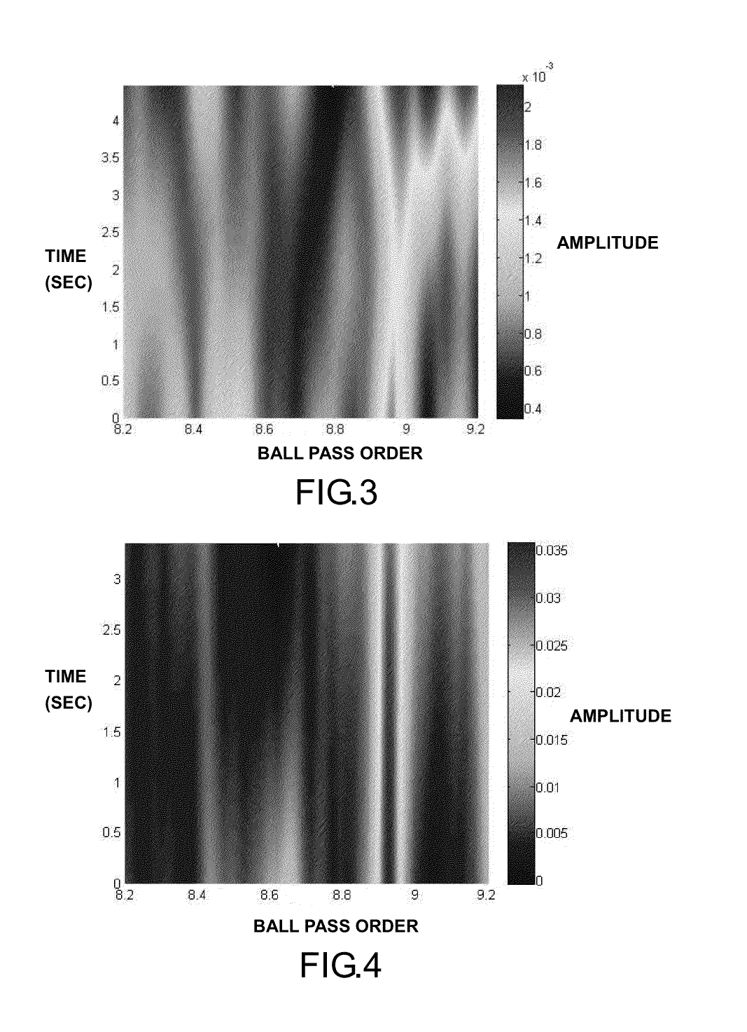

Referring to FIG. 3, the theoretical ball pass order is approximately 9.1, namely between 9 and 9.2, indicating that when the preload loss in the ball screw or the preload is reduced to certain degree, the theoretical ball pass order can be close to 9.1. Referring to FIG. 4, when the ball screw is of preload, the actual ball pass order is close to 8.93, indicating that the balls are forced by the preload coming from the screw nut to increase friction and thus the actual ball pass order is lower than the theoretical one. Besides, the frequency that the balls impinge the return tube is uniform, so the actual ball pass order is usually single and centralized. In view of FIGS. 3-4, when the preload becomes lower to certain degree, the frequency that the balls impinge the return tube is unstable, so the ball pass order will be scattered and abnormal order occurs while it is close to 8.98 where such abnormal order is known as the side band.

Although the preload-status of the ball screw can have been judged in the order comparison sub-procedure, if the judgment depends on nothing but the order comparison sub-procedure, misjudgment may happen. For this reason, when the theoretical ball pass order is different from the actual ball pass order, further judgment can be done via the quantification side band sub-procedure. In this way, whether the preload of the ball screw is sufficient or not can be accurately judged to effectively continue to be normally used.

Note that the rotary speed and vibration of the ball screw are though detected for further analysis in the aforesaid embodiment but in practice, the working sound of the ball screw can also be observed at the same time. In this way, the accuracy of the preload judgment can be further enhanced. Otherwise, detection of the rotary speed and sound of the ball screw can also reach the purpose of the preload observation of the ball screw. The working sound of the ball screw can be detected by a microphone. Thus, the detection is not limited to that of the rotary speed and vibration of the ball screw.

The step S52 further includes a sub-step of dividing the operational signal into a forward-trip signal and a backward-trip signal which indicate the operational statuses of the forward and backward trips of the ball screw, respectively. The preload status of the ball screw can be judged according to the forward-trip and backward-trip signals.

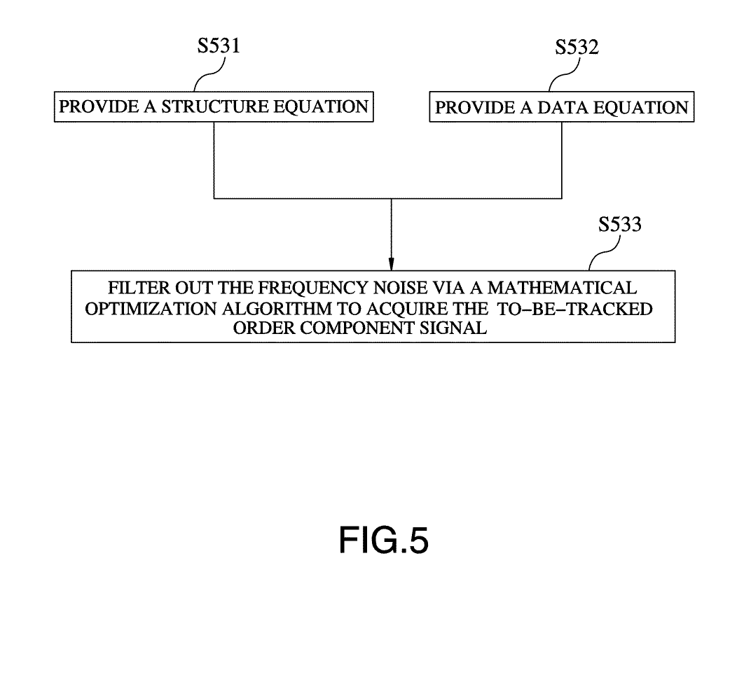

Referring to FIG. 5, the order tracking analysis procedure indicated in the step S53 includes the following sub-steps.

S531: Provide a structure equation for processing the operational signal to create a to-be-tracked order component signal.

S532: Provide a data equation for processing the operational signal to extract a frequency noise from the operational signal.

S533: Filter out the frequency noise via a mathematical optimization algorithm to acquire the to-be-tracked order component signal.

In practice, the order tracking analysis procedure formed of the sub-steps S531-533 is also know as Vold-Kalman filter (VKF) order tracking method. In the light of the sub-steps S531-533, the actual ball pass order of operation of the ball screw can be effectively tracked and observed and the noise other than the observed actual ball pass order can be filtered out. Beside, in this embodiment, the mathematical optimization algorithm is least square method. However, the noise can be filtered out via other mathematic computational models actually.

It is to be noted that preloads of various kinds of ball screws may be different from one another and thus the observed order ranges differ from one another. For this reason, the order tracking analysis procedure of the present invention can pick appropriate order ranges subject to different ball screws for small-range detailed tracking to further accurately observe the variations of the preloads of the ball screws. Besides, the calculation parameters of the mathematical optimization algorithm can be changed to enhance the resolution of the order tracking for the observation of higher resolution toward the observed order range.

What is claimed is:

1. A method of detecting a preload of a ball screw for tracking the preload of the ball screw via a detection device, a signal-capturing device, and a computer, the detection device being connected with or close to the ball screw for detecting an operational status of the ball screw, the operational status containing rotary speed of the ball screw and vibration or sound of the ball screw, the signal-capturing device being connected with the detection device and the computer for receiving and converting the operational status into an operational signal, the computer storing a preload judgment program, which can be operated by the computer to carry out the method when the ball screw is working, the method comprising steps of:
receiving the operational signal;
processing the operational signal;
carrying out an order tracking analysis procedure for statistical analysis of the operational signal for tracking an actual ball pass order of the ball screw;
providing a theoretical ball pass order indicating that the ball screw is devoid of any preload; and
carrying out a preload judgment procedure having an order comparison sub-procedure and a quantification side band sub-procedure where the order comparison sub-procedure is to compare difference between the actual ball pass order and the theoretical ball pass order and the quantification side band sub-procedure is to judge proportion of occurrence of side band around the actual ball pass order; if the order comparison sub-procedure judges that the actual ball pass order is away from the theoretical ball pass order, the preload judgment procedure will judge that the ball screw is of preload; if the order comparison sub-procedure judges that the actual ball pass order approaches the theoretical ball pass order and the quantification judgment procedure judges that the actual ball pass order is not accompanied with any side band, the preload judgment procedure will judge that the ball screw is of preload; if the order comparison procedure judges that the actual ball pass order approaches the theoretical ball pass order and the quantification side band procedure judges that the actual ball pass order is accompanied with certain side band, the preload judgment procedure judges that the ball screw is devoid of any preload.

2. The method as defined in claim 1, wherein the step of processing the operational signal further comprises a sub-step of dividing the operational status into a forward-trip signal and a backward-trip signal which indicate operational statuses of forward and backward trips of the ball screw, respectively.

3. The method as defined in claim 1, wherein the order tracking analysis procedure comprises sub-steps of.
providing a structure equation for processing the operational signal to create a to-be-tracked order component signal;
providing a data equation for processing the operational signal to extract a frequency noise from the operational signal; and
filtering out the frequency noise via a mathematical optimization algorithm to acquire the actual ball pass order of the to-be-tracked order component signal.
